(19) United States
(12) Patent Application Publication
(10) Pub. No.: US 2023/0229980 A1
(43) Pub. Date: Jul. 20, 2023

(54) FORECASTING APPARATUS, FORECASTING METHOD, AND STORAGE MEDIUM

(71) Applicant: OSAKA UNIVERSITY, Osaka (JP)

(72) Inventors: Koki KAWABATA, Osaka (JP); Yasuko SAKURAI, Osaka (JP); Takato HONDA, Osaka (JP); Yasushi SAKURAI, Osaka (JP)

(21) Appl. No.: 18/021,839

(22) PCT Filed: Jun. 30, 2021
(86) PCT No.: PCT/JP2021/024653

§ 371 Date: Feb. 17, 2023

(30) Foreign Application Priority Data
Aug. 20, 2020 (JP) 2020-139168

(51) Int. Cl. G06Q 10/04; G06F 17/16

(52) U.S. Cl. CPC G06Q 10/04; G06F 17/16

(57) ABSTRACT

A forecasting apparatus forecasts an event after a predetermined time, based on a current window being a part of time-series data in multidimension. The forecasting apparatus includes a non-linear transformation unit including a matrix for non-linear transformation, an observation matrix, and a seasonality setting unit. The non-linear transformation unit transforms the time-series data of the current window in a part of dimensions that are related to trends and the time-series data of the current window in a part of dimensions that are related to seasonal intensity into latent first data showing the trends and latent second data showing the seasonal intensity. The observation matrix includes a first observation matrix that reproduces the first data to first estimated data of an original number of dimensions, and a second observation matrix that, by use of seasonality information that has been set in the seasonality setting unit, reproduces the second data to second estimated data of an original number of dimensions, and adds the first estimated data and the second estimated data.

### TECHNICAL FIELD

The present invention relates to forecasting techniques that forecast an event for future in real time using some current windows in a data stream.

### BACKGROUND ART

Currently, large amounts of time-stamped data are generated and collected by a large number of advanced technologies and services such as IoT and Web access history. One of the most fundamental demands for marketing and other data science and engineering is to enable an efficient and effective analysis of big time-series data streams, such as real-time and long-term forecasting, to be implemented without human intervention, from collected data.

Patent Literature 1 and Non-Patent Literature 1 propose methods and apparatuses for a forecasting event value in real time through analysis of time-series data. These Literatures disclose a forecasting apparatus that enables a forecast by being configured so that a regime update means may perform processing to reduce a difference between data of a current window in a time-series data stream and an event value of the current window obtained using a mathematical model identified by a parameter set and determine a mathematical model, and a forecasting means then may output a future event value using the determined mathematical model. This forecasting apparatus, in particular, uses an adaptive non-linear dynamical system to capture an important feature or latent trends from the time-series data stream for future time-series forecasting in a long-term and continuous manner.

In these Literatures, when a large-scale time-series data stream is supplied, the latent pattern of the large-scale time-series data stream is represented by a mathematical model including a non-linear component. Then, in these Literatures, by using a non-linear dynamical system in which a parameter (such as an initial value, for example) except for the non-linear parameter is changed so as to maintain and adapt representation of the latent pattern due to the non-linear component, highly accurate event forecasting is enabled by use of a data stream in the real world. In other words, by defining a time-series pattern in a time-series data stream as a regime, and by using a regime shift in an event stream, forecasting accuracy is improved. In particular, the time-series data is represented as an adaptive non-linear dynamical system, which enables a complex time-series pattern to be represented in a flexible manner. Then, by using such an adaptive non-linear dynamical system, the forecasting accuracy is improved.

### CITATION LIST

### Patent Literature

[Patent Literature 1] International Publication No. 2018/012487

### Non-Patent Literature

[Non-Patent Literature 1] Yasuko Matsubara, Yasushi Sakurai, Christos Faloutsos: “Automatic Mining Feature from Large-Scale Time-Series Data,” DEIM Forum 2014 D4-2.

### SUMMARY OF INVENTION

### Technical Problem

Although the forecasting methods of the forecasting apparatuses that are disclosed in Patent Literature 1 and Non-Patent Literature 1 use an adaptive non-linear dynamical system, and, when receiving a large-scale data stream, capture an important feature or latent trends from the large-scale data stream, and are able to perform future time series forecasting in a long-term and continuous manner, an adaptive range of the non-linear dynamical system is limited. In addition, according to application or other factors, with more flexibility, these methods and apparatuses still have to be improved in higher accuracy and processing performance.

Incidentally, as the conventional analysis approach to time-series data, a Hidden Markov model (HMM) and other dynamic statistical models, and a Bayesian network (BN) probabilistic model have been known. However, these approaches are stochastic and discrete, and thus are unable to describe a dynamic and continuous activity or forecast a future dynamic pattern. Further, pHMM and AutoPlait, although being based on the HMM and having the ability to capture the dynamics of sequences and perform segmentation, are not designed to capture a long-range non-linear evolution. In addition, a data-driven non-linear forecasting method such as SMiLer or F4 tends to provide a result that is difficult to interpret and is unable to model a dynamic pattern in a stream.

Furthermore, traditional modeling and a forecasting approach typically use a linear method such as autoregressive integrated moving average (ARIMA), a linear dynamical system (LDS), and a Kalman filter (KF) as well as a derivative including AWSOM, TBATS, LiF and TriMine. These methods are fundamentally unsuitable for application. These methods are all based on a linear equation, and are thus unable to model data governed by a non-linear equation. Similarly, a switching state space model and a Switching Kalman Filter (SKF) model are designed as a combination of the Hidden Markov model with a set of linear dynamical systems. These, although being able to process multiple different patterns in time series, are not directed to capture dynamic space transitions. Therefore, a continuous and deterministic behavior between multiple regimes is unable to be modeled. In addition, RegimeCast, although focusing on real-time forecasting of an event stream, is not intended to perform regime identification and segmentation of a regime, and is unable to capture a shift between different dynamic patterns.

In contrast, deep learning, although having become one of the most popular methodologies in a data analysis task, has not been able to speed up for forecasting processing. A Recurrent Neural Network (RNN) encounters difficulties in modeling a long-distance dependency. Although a long short-term memory (LSTM) and a gated recurrent unit (GRU) reduce the above problem, all DNN variants need a high computational cost, especially training cost, for data stream analysis, and, besides, are difficult to forecast in real time. In addition, most of them need sensitive parameter tuning. In this way, none of the existing methods focuses specifically on the modeling and forecasting of the non-linear dynamics of co-evolution of multiple patterns in a data stream.

In view of the foregoing, the present invention provides a forecasting apparatus, a forecasting method, and a storage medium that are effective and have a high forecast accuracy.

### Solution to Problem

For example, in a case in which user behavior analysis related to a Web search activity is considered, observation is form of (a time stamp, a place, and a keyword), and is also called as a three-dimensional tensor. Therefore, multidirectional mining of a tensor stream is needed. In a case in which such a large tensor stream is provided, extraction of useful dynamics from a complex tensor and effective forecasting of future activity needs to be considered.

A problem involved in forecasting of the tensor stream has the following two causes. (a) Multiple factors behind observable data, that is, a large amount of time-series data includes several patterns such as a tendency (trends) and seasonality. Moreover, the true feature is unable to be known in advance. More importantly, such dynamic patterns are individually represented in several groups, for example, by place, product category, or the like, and it is extremely difficult to manually design an appropriate model for such a pattern. Therefore, a forecasting method from the tensor stream needs to be completely automated with respect to estimation of a parameter of a mathematical model, and the number of hidden dynamic patterns. As a result, a data structure is able to be understood, which makes it possible to save time and human resources. (b) Patterns that vary over time, that is, all elements of time series may vary as time passes for any of a variety of reasons such as a release of a new product. It is important to understand not only the tendency (the trends) and the seasonality but also a dynamic variation in the tendency and the seasonality. An individual pattern group is called a regime, and it is preferable to detect a variation in the individual pattern group, reflect the latest information in the mathematical model as soon as possible, and achieve highly accurate adaptive tensor forecasting.

A forecasting method and a forecasting apparatus (CubeCast) according to the present invention are proposed as a method or an apparatus that deals with a difficult problem of the real-time forecasting of the tensor stream and simultaneously captures the trends and the seasonality over time as well as multiple discrete patterns of the tensor stream.

In other words, a forecasting apparatus according to the present invention, in a forecasting apparatus that forecasts an event after a predetermined time by applying estimated data reproduced from time-series data in multidimension that passes through a current window, includes a storage unit that sequentially stores the time-series data in the multidimension that passes through the current window, a non-linear transformation unit that, among the time-series data in the multidimension to be outputted from the storage unit, from the time-series data in a part of dimensions that are related to trends, non-linearly transforms and outputs latent first data showing the trends, and, among the time-series data in the multidimension to be outputted from the storage unit, from the time-series data in a part of dimensions that are related to seasonal intensity, linearly transforms and outputs latent second data showing the seasonal intensity, and an observation matrix unit that includes a first observation matrix that reproduces the first data to first estimated data of an original number of dimensions, and a second observation matrix that, by use of seasonality information that has been set in a seasonality setting unit, reproduces the second data to second estimated data of an original number of dimensions, as seasonality data, and further adds output of the first observation matrix and the second observation matrix and outputs as the estimated data.

In addition, a forecasting method according to the present invention, in a forecasting method that forecasts an event after a predetermined time by applying estimated data reproduced from time-series data in multidimension that passes through a current window, includes sequentially storing in a storage unit the time-series data in the multidimension that passes through the current window, among the time-series data in the multidimension to be outputted from the storage unit, from the time-series data in a part of dimensions that are related to trends, non-linearly transforming and outputting latent first data showing the trends, and, among the time-series data in the multidimension to be outputted from the storage unit, from the time-series data in a part of dimensions that are related to seasonal intensity, and linearly transforming and outputting latent second data showing the seasonal intensity, and reproducing the first data to first estimated data of an original number of dimensions by a first observation matrix, and, by use of seasonality information that has been set in a seasonality setting unit, reproducing the second data to second estimated data of an original number of dimensions by a second observation matrix, as seasonality data, and further adding output of the first observation matrix and the second observation matrix and outputting as the estimated data.

Moreover, a non-transitory computer readable storage medium storing a program according to the present invention causes a computer to implement, in forecasting an event after a predetermined time by applying estimated data reproduced from time-series data in multidimension that passes through a current window, sequentially storing in a storage unit the time-series data in the multidimension that passes through the current window, among the time-series data in the multidimension to be outputted from the storage unit, from the time-series data in a part of dimensions that are related to trends, non-linearly transforming and outputting latent first data showing the trends, and, among the time-series data in the multidimension to be outputted from the storage unit, from the time-series data in a part of dimensions that are related to seasonal intensity, and linearly transforming and outputting latent second data showing the seasonal intensity, and reproducing the first data to first estimated data of an original number of dimensions by a first observation matrix, and, by use of seasonality information that has been set in a seasonality setting unit, reproducing the second data to second estimated data of an original number of dimensions by a second observation matrix, as seasonality data, and further adding output of the first observation matrix and the second observation matrix and outputting as the estimated data.

According to these inventions, from the time-series data of the current window in a part of dimensions that are related to trends and the time-series data of the current window in a part of dimensions that are related to seasonal intensity, by employing, for example, an adaptive non-linear dynamical system including a differential equation as the non-linear transformation unit, the latent first data showing the trends and the latent second data showing the seasonal intensity are extracted by non-linear transformation and by linear transformation, that is, transformed and generated. Then, the first data is reproduced by the first observation matrix to the first estimated data of the original number of dimensions, and the second data is reproduced by the second observation matrix to the second estimated data of the original number of dimensions, by use of seasonality information that has been set in the seasonality setting unit, and the first estimated data and the second estimated data are further added to output of the first observation matrix and the second observation matrix and outputted as the estimated data. Therefore, latent trends and seasonality are extracted from the time-series data, and reproduced so that original time-series data may be estimated by a model of the data of the latent trends and the seasonality. The forecasting, since being performed by the model at this time, is performed effectively and highly accurately.

### Advantageous Effects of the Disclosure

According to the present invention, effective and highly accurate forecasting apparatus, forecasting method, and storage medium are able to be provided.

### BRIEF DESCRIPTION OF DRAWINGS

FIG. 1 is an image diagram showing a configuration of a tensor stream X.

FIG. 2 is an image diagram showing a relationship between a current window X^{c} of the tensor stream X, and a forecasting window X^{f}.

FIG. 3 is a configuration diagram showing a first embodiment of a forecasting apparatus according to the present invention.

FIG. 4 is an image diagram showing a flow of processing to obtain an optimal mathematical model based on the current window X^{c}, and performs is-step ahead event forecasting accordingly.

FIG. 5 is a partial configuration diagram of a non-linear dynamical system that models d-dimensional time-series data into k-dimensional (<d) non-linear latent dynamics.

FIG. 6 is a partial configuration diagram of the non-linear dynamical system that reconstructs modeled latent information to original d-dimensional information.

FIG. 7 is a partial configuration diagram that is added to the configuration diagram of FIG. 5, and includes a non-linear dynamical system that models the d-dimensional time-series data into k-dimensional (<d) latent seasonal intensity.

FIG. 8 is a partial configuration diagram of a non-linear dynamical system that reconstructs modeled latent seasonal intensity and latent seasonality to the original d-dimensional information.

FIG. 9 is a configuration diagram of a reconstructed unit of the non-linear dynamical system.

FIG. 10 is a diagram illustrating types of regimes.

FIG. 11 is a view illustrating an example of a relationship between the types of regimes and regime assignment.

FIG. 12 is a view illustrating grouping of the regimes.

FIGS. 13A to 13I are views showing a fitting result (results in nine countries) of CubeCast to five apparel companies of Google (registered trademark) Trends, and FIG. 13A is a view showing a case of the United States, FIG. 13B is a view showing a case of China, FIG. 13C is a view showing a case of Germany, FIG. 13D is a view showing a case of the United Kingdom, FIG. 13E is a view showing a case of India, FIG. 13F is a view showing a case of Brazil, FIG. 13G is a view showing a case of Japan, FIG. 13H is a view showing a case of France, and FIG. 13I is a view showing a case of Italy.

FIG. 14 is a view showing average forecasting accuracy in CubeCast and a comparative example method.

FIG. 15 is a view showing average wall clock time in Google (registered trademark) Trends and the comparative example method.

FIGS. 16A and 16B are views showing a relationship between the average wall clock time and a size of the tensor stream in CubeCast, that is, FIG. 16A shows a relationship with duration (tc) and FIG. 16B shows a relationship with the number of countries (d1).

FIG. 17 is a table showing presence or absence of functions between CubeCast and the comparative example method.

### DESCRIPTION OF EMBODIMENTS

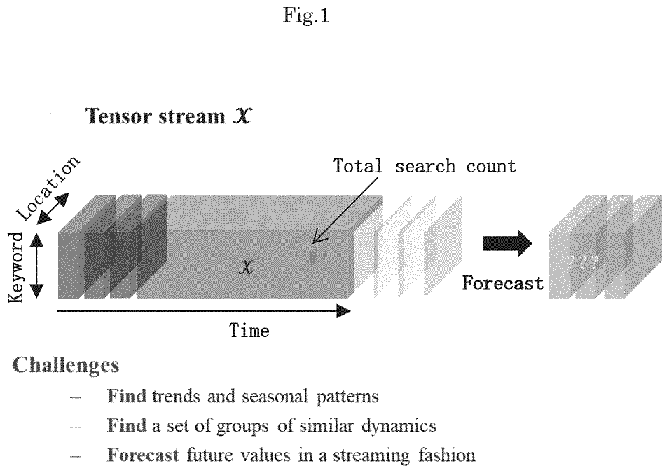

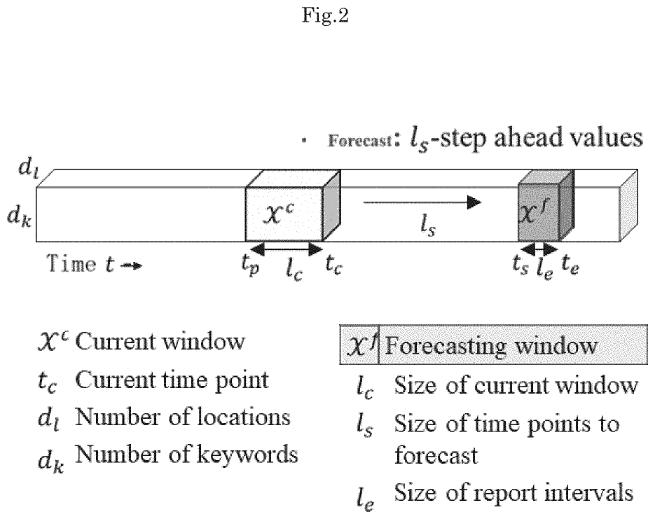

A large amount of time-series data that includes information on time evolution is able to be represented as a tensor, and is more specifically shown in Mathematical Formula 1, FIG. 1, and FIG. 2.

Given a tensor stream X up to the current time point t_{c}, which consists of elements at dₗ locations for dₖ key-words, i.e., X={xₜᵢⱼ}_{t, i, j=1}^{t}^{_{c}}^{, d}^{ₗ}^{, d}^{ₖ}, [Mathematical Formula 1]
find trends and seasonal patterns
find a set of groups (Le., regimes) of similar dynamics
forecast lₛ-step ahead future values, i.e., X^{f}={xₜᵢⱼ} where (t=t_{c}+lₛ; i=1, . . . , dₗ; j=1, . . . , dₖ)
continuously and automatically in a streaming fashion.

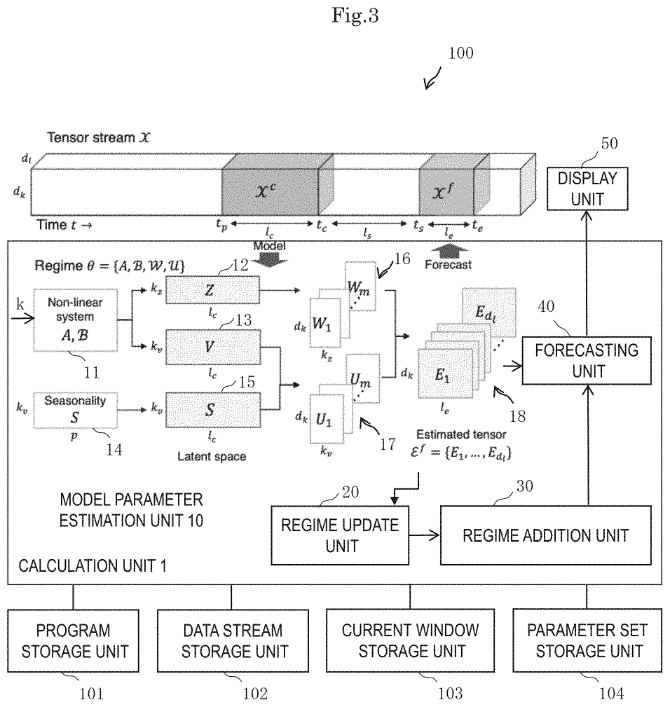

In other words, the forecasting apparatus (hereafter referred to as CubeCast and will be described below in FIG. 3.) according to the present invention solves the following problems. More specifically, as shown in FIG. 1, for example, a Web access history is a three-dimensional tensor stream obtained by imaging a box shape with a vertical-axis direction as a keyword and with a horizontal-axis direction as a location (Location) and generating the box shape along a time point (Time) tc in a time-series direction. It is to be noted that information on Location is sequentially accumulated in the right direction in FIG. 1, that is, toward a future direction, by receiving access information for multiple (three, for example) box shapes at every 1 time point tc. Three box shapes on the right end show forecasted future forecast information in an imaginary way.

In addition, as shown in Mathematical Formula 1 and FIG. 2, when a tensor stream X being time-series data up to a current time point tc to be configured by an element at a location dl of a keyword dk is given, that is, X={x_{t i j}}^{tc, dl, dk}_{t, i, j=1} is given, as described below, (a) a tendency (trends) and a seasonal pattern are found, (b) a pattern (a regime) of groups of similar dynamics is found, and (c) an ls-step ahead (future) forecast value, that is, X^{f}={x_{t i j}} is generated. Herein, t=tc+ls; i=1, . . . , dl; j=1, . . . dk. It is to be noted that a part of characters used for a formula is written in the standard form in this text.

Subsequently, Table 1 shows a list of main symbols used by CubeCast.

TABLE 1

| Symbol | Definition |
|---|---|
| dₖ, dₗ | Number of keywords and locations |
| t_{c} | Current time point |
| χ | Tensor stream, i.e., χ ∈ [symbol] |
| χₜ_{ₛ}_{:t}_{ₑ} | The partial tensor of χ from time point tₛ to tₑ |
| χ_{:, i} | Time series for the i-th country, i.e., χ_{:, i} ∈ [symbol] ^{t}^{_{c}}^{×d}ₖ |
| k_{z}, kᵥ | Number of latent states for base trends and seasonality |
| Z | Latent variables for base trends, i.e., Z = (z₁, . . . , zₜ}, zᵢ ∈ [symbol] ^{k}^{_{z}} |
| V | Latent variables for seasonality, i.e., V = (v₁, . . . , vₜ}, vᵢ ∈ [symbol] ^{k}^{ᵥ} |
| A, [symbol] | Non-linear dynamical system, i.e,, A ∈ [symbol] ^{k×k}, [symbol] ∈ [symbol] ^{k×k×k}, k = k_{z} + kᵥ |
| [symbol] | Observation matrix set for base trends, i.e., [symbol] = {W₁, . . . , Wₘ} |
| [symbol] | Observation matrix set for seasonality, i.e., [symbol] = {U₁, . . . , Uₘ} |
| p | Period of seasonality |
| S | Latent seasonal components, i.e., S ∈ [symbol] ^{p×k}^{ᵥ} |
| ε | Estimated variables, ie., ε ∈ [symbol] ^{t}^{_{c}}^{×d}ₗ×dₖ |
| m | Number of local groups in a regime |
| n | Number of regimes |
| θ | Regime parameter set, i.e., θ = {A, [symbol] , [symbol] , [symbol] } |
| Θ | Full parameter set, ie., Θ = {S, θ₁, . . . , θₙ} |
| [symbol] | Regime assignment set, ie., [symbol] = {r₁, . . . , rₙ} |

The tensor stream X is considered as a three-dimensional tensor. This is indicated by X ∈ R^{tc×dl×dk}. Herein, tc denotes the number of time points, and dl and dk respectively denote the number of locations and the number of keywords. An element xₜᵢⱼ corresponds to a search volume at time point t of an i-th location of a j-th keyword. The overall objective is to achieve long-term forecasting of a tensor X while adapting to the latest trends. In addition, as shown in FIG. 2, as a partial tensor of X. X^{c}={xₜᵢⱼ}^{tc, dl, dk}_{t, i, j=tp,} 1, 1 is defined as a current window. The length is indicated by lc. In other words, tp=tc−lc. The lc indicates a data period that CubeCast retains.

(lₛ-STEP AHEAD FORECASTING). Given: a data stream X^{c}={x^{tij}}_{t, i, j=t}_{ₚ}_{, 1, 1}^{t}^{_{c}}^{, d}^{ₗ}^{, d}^{ₖ}, where, t_{c} is the current time point and tₚ=t_{c}−l_{c}; Forecast: lₛ-steps ahead future values X^{f}={xₜᵢⱼ}_{t, i, j=t}_{ₛ}_{,1,1}^{t}^{ₑ}^{, d}^{ₗ}^{, d}^{ₖ} where tₛ=t_{c}+lₛ and tₑ=tₛ+lₑ. [Mathematical Formula 2]

In addition, as shown in Mathematical Formula 2 and FIG. 2, for ls-step ahead forecasting, a given data stream X^{c} is {xₜᵢⱼ}^{te, dl, dk}_{t, i, j=ts, 1, 1} and a partial tensor from ts=tc+ls to te=ts+le is shown and called a forecasting window. Herein, ls and le are respectively defined as a forecasting time point and a regular time interval for reporting.

CubeCast models a latent dynamic pattern served as a foundation of a tensor stream, in order to capture all the above components.

FIG. 3 is a configuration diagram showing a first embodiment of a forecasting apparatus 100 (CubeCast) according to the present invention. The forecasting apparatus 100 (CubeCast) includes a calculation unit 1 including a processor (a CPU), and a program storage unit 101, a data stream storage unit 102, a current window storage unit 103, and a parameter set storage unit 104 that are connected to the calculation unit 1. The calculation unit 1 further includes a model parameter estimation unit 10, a regime update unit 20, a regime addition unit 30, and a forecasting unit 40. In addition, the calculation unit 1 includes a display unit 50 that displays a forecast result. It is to be noted that the display unit 50 may be configured by a touch panel and may be able to receive a predetermined instruction input from a user side. A publicly known operation unit such as a keyboard may be provided for a user input. Hereinafter, each configuration will be described, and more details will be described with reference to the corresponding drawings below.

The program storage unit 101 stores a processing program (such as an algorithm to be described below) that CubeCast executes. It is to be noted that the algorithm, by being read out to a main memory (not shown) and executed by a processor, functions as each part 10 to 40 of the calculation unit 1. The data stream storage unit 102 stores search data, and data for a period older than the current window X^{c} is compressed to be able to be reproduced as needed. The current window storage unit 103 updates and stores time-series data of a current window X^{c} period for every time point tc. The parameter set storage unit 104 stores various kinds of parameter sets that construct the mathematical model for reproducing estimated data from the time-series data.

The model parameter estimation unit 10 includes a non-linear transformation unit 11 into which the time-series data of the current window X^{c} is inputted, latent spaces 12 and 13, a seasonality setting unit 14, and a latent space 15, and also includes observation matrices 16 and 17, and an estimated tensor space 18. It is to be noted that the latent spaces 12, 13, and the estimated tensor space 18 may be memories that are sequentially recorded as the time-series data, or may be employed for illustrative purposes. In addition, calculations in the non-linear transformation unit 11 and the observation matrices 16 and 17 may be either software calculations or hardware processing.

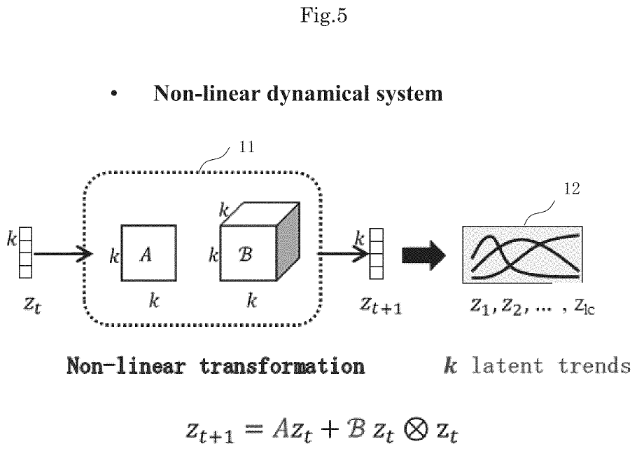

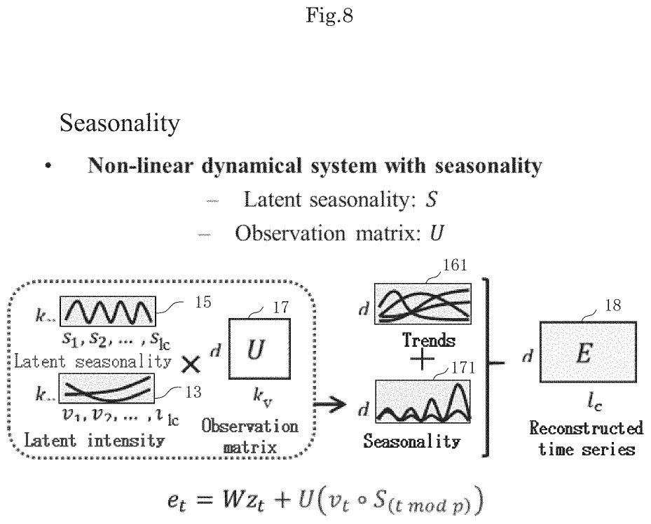

The non-linear transformation unit 11, as described below, latently retrieves (captures) large trends included in the time-series data searched (detected) in a d-dimension with k [[(]] dimension (k<d), and is configured by a two-dimensional matrix A and a three-dimensional tensor matrix B that are connected in series, as shown in FIG. 5. The two-dimensional matrix A and the three-dimensional tensor matrix B are configured by parameters of a non-linear differential equation respectively corresponding to linear transformation and non-linear transformation, and, by preparing a plurality of non-linear transformation units and providing a mechanism to select a non-linear transformation unit according to a tendency of the time-series data, for example, an adaptive non-linear dynamical system becomes applicable. The non-linear transformation unit 11, as shown in FIG. 5, receives an input of data at time point t, and forecasts an output of the next time point t+1. In this configuration, latent information zt on trends to be outputted from the non-linear transformation unit 11 is led to the observation matrix 16 through the latent space 12, and, on the other hand, information on latent seasonal intensity vt to be outputted from the non-linear transformation unit 11 is led to the observation matrix 17 through the latent space 13. In addition, information on latent seasonality S to be outputted from the seasonality setting unit 14 is led to the observation matrix 17 through the latent space 15. In the observation matrix 17, the seasonal intensity vt and the seasonality S are multiplied by each other. The latent information zt on trends is transformed and generated into d-dimensional reproduction information by the observation matrix 16. Moreover, the d-dimensional seasonal intensity vt and the seasonality S are transformed and generated into d-dimensional reproduction information by the observation matrix 17. The information through the observation matrices 16 and 17 is outputted to the estimated tensor space 18. More details will be described in FIG. 8.

In addition, the observation matrices 16 and 17 are set up by not only one type for a location (a region, for example) but also multiple, for example, m weight matrices to reflect singularity with respect to the location, which maintains the accuracy of the forecast information (an event) to be reproduced through a model. For example, the observation matrices W1, W2, . . . , and Wm are provided in the observation matrix 16, and the observation matrices U1, U2, . . . , and Um are corresponded to the observation matrix 16, as shown in FIG. 3, and provided in the observation matrix 17.

The regime update unit 20 causes the estimated data reproduced in the estimated tensor space 18 to correspond to the information of the current window Xc, and totals each difference as a square error, and alternately corrects, from a total result, matrices W and U of the observation matrices 16 and 17 and the matrix A and the matrix B of the tensor of the non-linear transformation unit 11, and the value of the latent seasonality S, and enables both the trends and the seasonality to be adjusted with well balance so that the total of the difference may be within a predetermined threshold value.

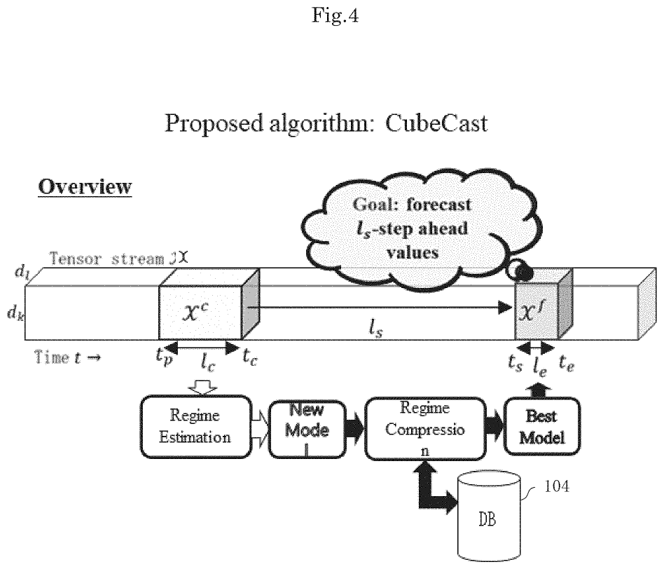

In addition, the regime update unit 20 applies the principle of the minimum description length (MDL: minimum description length), for example, as an automatic evaluation method for automatically detecting an optimal model set (a regime). The details will be described below. The regime addition unit 30, as shown in an image diagram in FIG. 4, estimates a new regime θ, and, in a case of obtaining evaluation by MDL and setting as a new regime θ, the parameter set of this regime θ is stored in the parameter set storage unit 104. The forecasting unit 40, by applying the optimal regime to the time-series data stream from the current window X^{c}, generates an is-step ahead forecasting event.

Subsequently, each function and operation that CubeCast has will be described. CubeCast has the following three functions (a) to (c).

(a) Non-linear latent dynamics: CubeCast employs a non-linear dynamical system to capture about complex dynamics (trends) in time series,

(b) Seasonality: The non-linear dynamical system is extended to handle seasonality that evolves over time, and

(c) Co-evolving patterns in tensor streams: An adaptive model that is able to describe both temporal and locational differences in tensor streams.

(a): Latent non-linear dynamics in a single location (place): The simplest case is first considered. For example, hypothetically, there is a single dynamical pattern to which d-dimensional time series are given, such as search volumes for a single country. It is to be noted that, in a basic model, the time series have latent activities and these are assumed to determine behavior of the time series that are actually observed.
zt: kz-dimensional (<d) latent activity at time point t.
et: d-dimensional time-series estimated event observed at time point t.

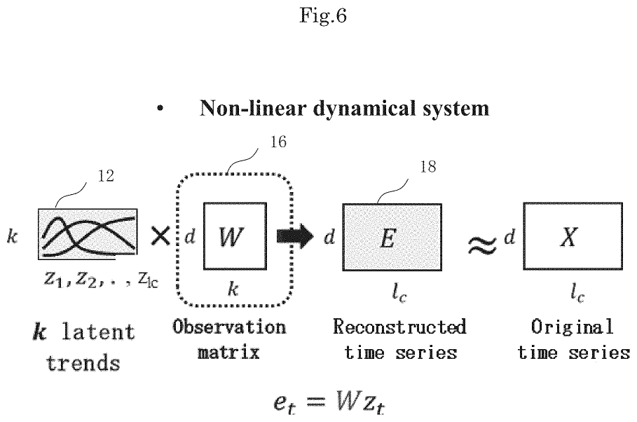

In other words, although the actual activity et is able to be observed, the latent activity zt is an unobservable vector that describes non-linear dynamics evolving over time. As shown in FIG. 5, input data zt is outputted as a latent activity zt+1 at time point t+1 through the matrix A of the non-linear transformation unit 11 and the tensor B. Further, as shown in FIG. 6, the latent activity of the non-linear dynamics outputted from the non-linear transformation unit 11 is able to recursively generate (restore) a d-dimensional signal et through the observation matrix 16. The temporal dependency of these activities is able to be indicated by the following Mathematical Formula 3.

zₜ₊₁=Azₜ+ [symbol] zₜ \textcircled{×}zₜ,

eₜ=Wzₜ, [Mathematical Formula 3]

Herein, the symbol “X is written in ∘” in the second term on the right side of the first equation in Mathematical Formula 3 is an operator that indicates the outer product of two vectors. A ∈ R^{kz×kz} and B ∈ R^{kz×kz×kz} describe linear/non-linear dynamical activities. W ∈ R^{d×kz} indicates observation forecasting for obtaining an estimated event et from the latent activity zt.

(b) For latent seasonal variation: Mathematical Formula 3 being the basic model is extended, and seasonal/cyclic patterns are modeled in time series. More specifically, another latent factor of seasonality that may be able to interact with linear/non-linear activities over time is defined. For example, an intensifying seasonal pattern in conjunction with latent trends is represented. For this purpose, two additional types of latent activities are assumed here.
vt: latent seasonal intensity at time point t, that is, vt ∈ R^{kv}
S: latent seasonality, that is, S ∈ R^{p×kv}

Herein, kv indicates the number of dimensions of a latent space for seasonality, and p is a seasonal period.

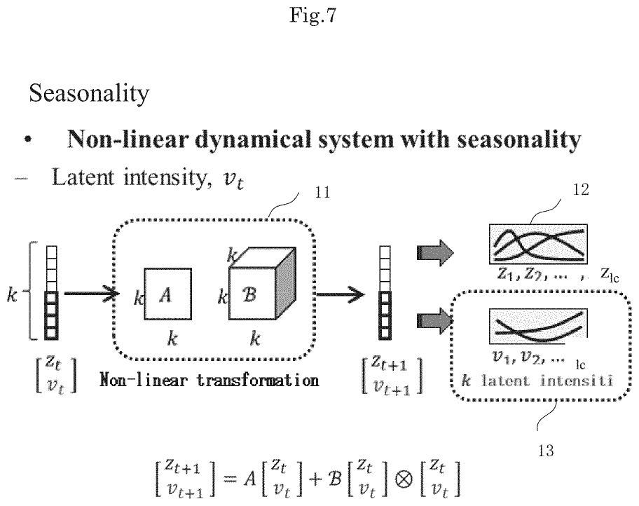

FIG. 7 adds a configuration in which seasonal intensity vt is reflected to the configuration of FIG. 5, and places a signal line for a predetermined dimension on an input/output side. For example, the same number of dimensions for latent activity and latent seasonal intensity on the dynamic trend side are added up to k-dimension (four dimensions each in FIG. 7). A signal outputted from the non-linear transformation unit 11 is the latent activity zt of the non-linear dynamics (see the latent space 12) in the four dimensions on the one hand, and the latent seasonal intensity vt (see the latent space 13) in the four dimensions on the other hand. Then, as shown in FIG. 8, the latent seasonal intensity vt (see the latent space 13) and the latent seasonality S (see the latent space 15) are multiplied by a matrix U of the observation matrix 17, so that the d-dimensional seasonality data (see a latent space 171) is reproduced, and is further reproduced as an estimated vector et obtained by adding this and trend data (see the latent space 161). Therefore, Mathematical Formula 3 is rewritten as Mathematical Formula 4.

$$[ \begin{matrix}{z}_{t + 1} \\ {v}_{t + l}\end{matrix} ] = A [ \begin{matrix}{z}_{t} \\ {v}_{t}\end{matrix} ] + ℬ [ \begin{matrix}{z}_{t} \\ {v}_{t}\end{matrix} ] ⊗ [ \begin{matrix}{z}_{t} \\ {v}_{t}\end{matrix} ] , \qquad [ Mathematical Formula 4 ]$$

$${e}_{t} = {Wz}_{t} + U ( {v}_{t} ◦ {S}_{t mod p} ) ,$$

Herein, the symbol ∘ in the second equation is an operator that shows an element-wise product of two vectors. A and B are respectively extended to A ∈ R^{k×k} and B ∈ R^{k×k×k}. Herein, k=kz+kv. The estimated vector et is obtained by the observation matrix U ∈ R^{d×kv} for a seasonal latent activity vv and seasonality S as well as W ∈ R^{d×kz} for latent trends zt. Once the initial states z0 and v0 are obtained, the latent state at the next time point is able to be recursively generated by use of a single common dynamical system. As a result, the latent interaction between a tendency and seasonality is able to be extracted.

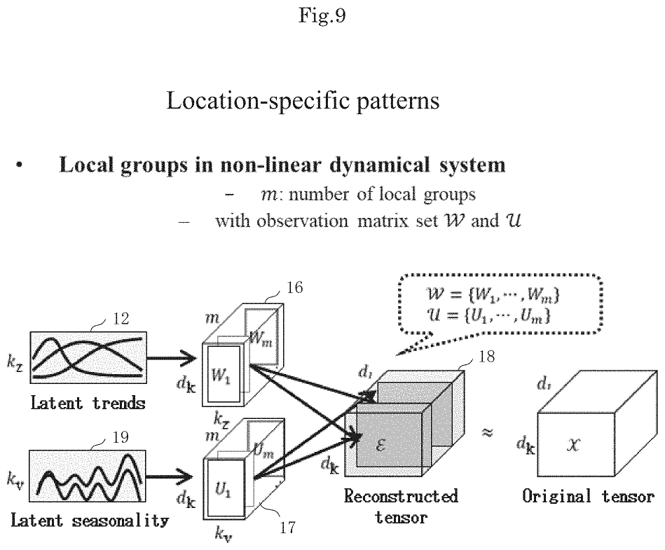

(c) A complete model with multiple locations (places): Multiple different activities in terms of locations are assumed. The equation (Mathematical Formula 4) being the non-linear dynamical system is further extended to enable both time-changing and location-specific patterns to be identified. Here, it is assumed that there is a three-dimensional tensor X. Specifically, the tensor needs to be divided along the second mode, that is, the location dl, into a set of m local groups (m<dl) in order to capture a location-specific activity. That is, a dynamical pattern at the i-th location is able to be described by one of the sets of the observation matrix Wi and the observation matrix Ui. Herein, i ∈ {1, . . . , m}, a single space given by A and B in Mathematical Formula 4 is shared. Accordingly, similar time series share a similar latent non-linear factor. As shown in FIG. 9, the observation matrix W and the observation matrix U are divided into m pieces corresponding to locations, and are created as W1, . . . , Wm, and U1, . . . , Um. Then, by use of the selected observation matrix Wi and observation matrix Ui, from the latent activity zt of the latent space 12 and the latent seasonality of the latent space 19, the estimated vector et corresponding to the location i is reproduced.

E ∈ R^{tc×dl×dk} is defined as an estimation tensor of X ∈ R^{tc×dl×dk}. In a case in which an observation vector xₜᵢ ∈ X for the i-th location at time t is modeled by using the j-th observation matrix, an estimated vector eₜᵢ ∈ E is described as the following Mathematical Formula 5. Subsequently, as shown in Mathematical Formula 6, θ is used as a parameter set of a single non-linear dynamical system and is represented by θ={A, B, W, U}.

$$[ \begin{matrix}{z}_{t + 1} \\ {v}_{t + l}\end{matrix} ] = A [ \begin{matrix}{z}_{t} \\ {v}_{t}\end{matrix} ] + ℬ [ \begin{matrix}{z}_{t} \\ {v}_{t}\end{matrix} ] ⊗ [ \begin{matrix}{z}_{t} \\ {v}_{t}\end{matrix} ] , \qquad [ Mathematical Formula 5 ]$$

$${e}_{ti} = {W}_{j} {z}_{t} + {U}_{j} ( {v}_{t} ◦ {S}_{t mod p} ) ,$$

where i=1, . . . , dₗ and j=1, . . . , m.

(Single regime parameter set). Let θ be the parameter set of a single non-linear dynamical system, namely θ={A, [symbol] , [symbol] , [symbol] }, where [symbol] and [symbol] are sets of observation matrices for m local groups, i.e., [symbol] ={W₁, . . . , Wₘ} and [symbol] ={U₁, . . . , Uₘ}. [Mathematical Formula 6]

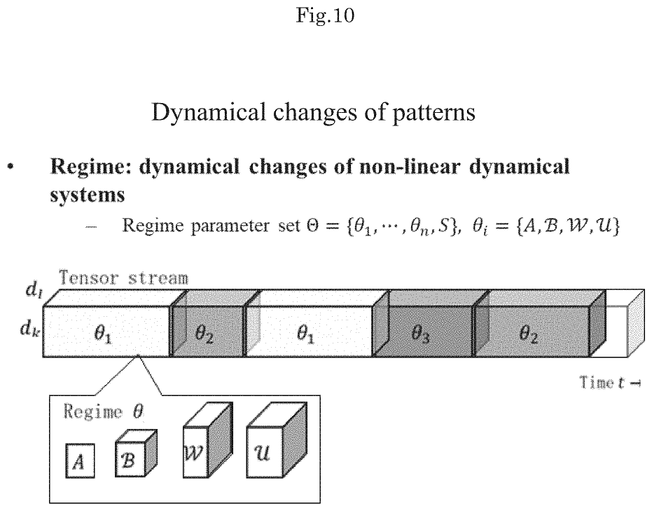

Furthermore, in a case in which regime transition between clear latent dynamics is detected, n is denoted as the proper number of regimes up to the current time point. More specifically, as shown in FIG. 10, the tensor X includes a set of n regimes, that is, {θ1, . . . , θn}, and thus, as a complete model set of tensor streams, a full parameter set Θ={θ1, . . . , θn, S} being multiple non-linear patterns with seasonality is provided. It is to be noted that, in the present embodiment, the latent seasonality S is placed on the outside of the regime θ. The present model uses a different regime θ ∈ Θ that depends on a time-varying pattern. Therefore, assignment of a regime at each time as well as assignment of a local group belonging to each regime need to be determined.

(Regime assignment set). Let [symbol] be a full regime assignment set for Θ, namely, [symbol] ={r₁, . . . , rₙ}, where rᵢ={r₁, . . . , rⱼ, . . . , r_{d}_{ₗ}} is a set of dₗ integers for the i-th regime θᵢ, and thus rⱼ ∈ {1, . . . , mᵢ} is the local group index to which the j-th country belongs. [Mathematical Formula 7]

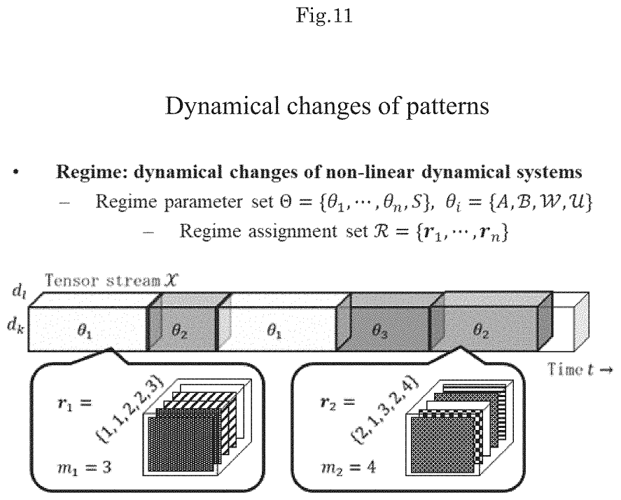

R is a complete regime assignment set of Θ, that is, R={r1, . . . , rn}, ri={r1, . . . , rj, . . . , rd1} is a set of integers dl for the i-th regime θᵢ. Therefore, rj ∈ {1, . . . , mi} is a local group index to which the j-th location, for example, a country, belongs. For example, in FIG. 11, the number n of regimes is 3, the regime θ1 is the number m of local groups=3, and the regime θ2 is the number m of local groups=4. Then, for example, in the regime θ1, r1={1, 1, 2, 2, 3}, that is, the first and second locations (countries, for example) indicate group 1, the third and fourth locations (countries, for example) indicate group 2, and the fifth location (a country, for example) indicates group 3.

Table 2 is an algorithm that shows a processing procedure of algorithm 1 CubeCast (Xc, Θ, R).

TABLE 2
Algorithm 1 CUBECAST (χ^{c}, Θ, [symbol] )

| Input: | | (a) Current tensor χ^{c} |
|---|---|---|
| | | (b) Full parameter set Θ |
| | | (c) Regime assignment set [symbol] |
| Output: | | (a) lₛ -steps-ahead future values ε^{f} |
| | | (b) Updated full parameter set Θ′ |
| | | (c) Updated regime assignment set [symbol] ′ |
| | 1: | /* (I) Estimate a new regime for given data */ |
| | 2: | {θ, r} ←REGIMEESTIMATION (χ^{c}, S); // S ϵ Θ |
| | 3: | /* (II) Update model set and detect current dynamics */ |
| | 4: | {Θ′, [symbol] ′} ←REGIMECOMPRESSION (χ^{c}, Θ, [symbol] , θ, r); |
| | 5: | /* (III) Generate future values using a current regime */ |
| | 6: | $\{ θ , r \} ← {arg min}_{{θ}^{′} ϵ {θ}^{′} , {r}^{′} {ϵ}^{′} {R}^{′}} ‖ {χ}^{c} - f ( {θ}^{′} , {r}^{′} ) ‖ // f ( . , . ) : Equation ( 3 )$ |
| | 7: | ε^{f} ← f(θ, r); // ε^{f} = {eₜᵢⱼ}_{t,i,j=t}_{ₛ}_{,1,1},^{t}^{ₑ}^{,d}^{ₗ}^{,d}^{ₖ} |
| | 8: | return {ε^{f}, Θ′, [symbol] ′}; |

Based on Table 2, optimization algorithms for the real-time forecasting of co-evolving tensor streams will be described. In the above, a model based on a non-linear dynamical system has been proposed. In order to effectively and accurately forecast a future event by use of the model, the following two problems need to be addressed. Specifically, (a) forecasting a future event in real time while adaptively generating and switching regimes, and (b) automatic mining, and estimating multiple non-linear dynamics.

With respect to the problem (a), an effective way is needed to manage the entire model structure step-by-step so as to detect regime switching to another known/unknown regime. With respect to the problem (b), a criterion is needed to determine a sufficiently compressed model that is able to capture the underlying dynamics of data without any human intervention. CubeCast is a streaming algorithm that achieves such problems (a) and (b). The algorithm of Table 2 shows the overall procedure of CubeCast. The basic idea of the algorithm is a tensor encoding system. This updates all the components in a parameter set Θ while processing a current tensor X^{c}.

More specifically, the algorithm is configured by the following elements (1) to (3).

(1) Regime Estimation: Estimating a non-linear dynamical system from zero. Namely, the current tensor X^{c} is designated to estimate θ. In addition, regime assignment r is placed to divide the tensor and add a set of observation matrices in W and U to the regime θ.

(2) Regime Compression: Updating all the parameter set Θ and regime assignment set R by use of the current tensor X^{c} and a newly estimated regime θ and regime assignment r for X^{c}. In this step, the algorithm determines whether or not to employ a new regime θ and selects an optimal regime for X^{c}. After the regime assignment set R is updated, the seasonality S is also updated.

(3) Finally, an is-step ahead future event tensor E^{f}={eₜᵢⱼ}^{te,dl,dk}_{t, i, j=ts, 1, 1} according to Mathematical Formula 5 by use of the most suitable regime θ and the regime assignment r for X^{c} selected by Regime Compression.

Subsequently, an automatic tensor summarization will be described. In this example, an objective function will be described with respect to the minimum description length (MDL) principle in order to automatically detect the optimal model set. According to the MDL principle, as shown in Mathematical Formula 8, the nature of a good summarization is determined by minimizing the sum of the model description cost and data encoding cost as follows.

$$Θ = {arg min}_{{Θ}^{′}} < {Θ}^{′} > + < 𝒳 \vert {Θ}^{′} > , \qquad [ Mathematical Formula 8 ]$$

Herein, <Θ′> represents the describing cost, and <X |Θ′> represents the cost of describing the data X to which the model θ′ is given. In other words, the above follows the assumption that the more data is able to be compressed, the more is able to be learned about the underlying pattern. Therefore, in the present algorithm, two costs that have a trade-off relationship to each other are proposed for the model.

Subsequently, the model description cost will be described. The class of the model parameter set that needs to be searched is parameterized by the number of latent states for trends and seasonality as well as the number of regimes. Once these numerical values are obtained, as shown in Mathematical Formula 9, the description complexity of the entire model with the following terms is calculated.
The dimensionality of a tensor:

<t_{c}>=log*(t_{c})¹, <dₗ>=log*(dₗ), <dₖ>=log*(dₖ)
The dimensionality of latent components:

<k_{z}>=log*(k_{z}), <kᵥ>=log*(kᵥ), <p>=log*(p).
Seasonality:

<S>=|S|·(log(p)+log(kᵥ)+c_{F})+log*(|S|).
Single regime parameter set:

<θ>=<k_{z}>+<A>+<B>+<W>+<U>. [Mathematical Formula 9]

Herein, |·| describes the number of non-zero elements and cF denotes the floating point cost. The model description cost of each component in <θ> is defined as the following Mathematical Formula 10.

<A>=|A|·(2·log(k)+c_{F})+log*(|A|),

< [symbol] >=| [symbol] |·(3·log(k)+c_{F})+log*(| [symbol] |),

< [symbol] >=Σᵢ₌₁^{m}|Wᵢ|·(log(dₖ)+log(k_{z})+c_{F})+log*(|Wᵢ|),

< [symbol] >=Σᵢ₌₁^{m}|Uᵢ|·(log(dₖ)+log(kᵥ)+c_{F})+log*(|Uᵢ|). [Mathematical Formula 10]

Subsequently, the data encoding cost will be described. The data X is able to be encoded by use of 8 based on the publicly known Huffman coding. The coding scheme assigns the number of bits to each value in X. This is the negative log-likelihood under a Gaussian distribution with mean μ and variance σ², which is represented by Mathematical Formula 11.

$$< 𝒳 \vert Θ >= {\sum }_{t , i , j = 1}^{{t}_{c} , {d}_{k} , {d}_{l}} - {log}_{2} {p}_{μ , σ} ( {x}_{tij} - {e}_{tij} ) , \qquad [ Mathematical Formula 11 ]$$

Herein, e_{t ij} ∈ E shows a reconstruction value of x_{t ij} ∈ X used in Mathematical Formula 5. Finally, the total encoding cost <X; Θ> is obtained as shown in Mathematical Formula 12.

$$\begin{matrix}< 𝒳 ; Θ >= < Θ > + < 𝒳 \vert Θ > \\ = < {t}_{c} > + < {d}_{l} > + < {d}_{k} > + < p > \\ + < {k}_{υ} > + < S > + {\sum }_{i = 1}^{n} < {θ}_{i} > + < 𝒳 \vert Θ >\end{matrix} . \qquad [ Mathematical Formula 12 ]$$

Subsequently, regime estimation will be described. It is difficult to find the global optimal solution of Mathematical Formula 12 due to interdependent components in the model. In other words, (a) latent dynamical systems A and B, (b) matrices in the observation matrices W and U, and (c) seasonality S, and therefore, the optimal local pattern of components (a) and (b) are aimed to be found by first using a greedy approach. More specifically, the algorithm 2 of Regime Estimation to minimize an equation (Mathematical Formula 12) for a tensor X^{c} is provided as shown in Table 3.

TABLE 3
Algorithm 2 REGIMEESTIMATION (χ^{c}, S)

Input: Current tensor χ^{c} and seasonality S
Output: Regime parameter set θ and regime assignment r

| | |
|---|---|
| 1: | [symbol] = ϕ; [symbol] = ϕ; r = {rᵢ = 1\|i = 1, . . . , dₗ}; |
| 2: | [symbol] * = ϕ; [symbol] * = ϕ; // candidate observation matrix set |
| 3: | /* Estimate a regime with a single local activity */ |
| 4: | $\{ A , ℬ , W , U \} ← {arg min}_{{θ}^{′} = \{ {A}^{′} , {ℬ}^{′} , {W}^{′} , {U}^{′} \}} < {χ}^{c} ; S , {θ}^{′} , r > ;$ |
| 5: | Push W into [symbol] *; Push U into [symbol] *; |
| 6: | /* Estimate local activities */ |
| 7: | while [symbol] * and [symbol] * are not empty do |
| 8: | Pop an entry W₀ from [symbol] *; Pop an entry U₀ from [symbol] *; |
| 9: | θ ← {A, [symbol] , [symbol] _{F}, [symbol] _{F}}; // [symbol] _{F} = [symbol] ∪ [symbol] * ∪ {W₀} |
| 10: | Initialize r*; Initialize W₁, W₂, U₁, U₂; |
| 11: | θ* ← {A*, [symbol] *, [symbol] _{F}*, [symbol] _{F}*}; //A* = A, [symbol] * = [symbol] |
| 12: | // [symbol] _{F}* = [symbol] ∪ [symbol] * ∪ {W₁, W₂}, [symbol] _{F}* = [symbol] ∪ [symbol] * ∪ |
| | {U₁, U₂} |
| 13: | while < χ^{c}; S, θ*, r* > is improved do |
| 14: | Estimate r*; |
| 15: | Estimate W₁, W₂, U₁, U₂; |
| 16: | Estimate A*, [symbol] *; |
| 17: | end while |
| 18: | if < χ^{c}; S, θ*, r* > is less than < χ^{c}; S, θ, r > then |
| 19: | Push {W₁, W₂} into [symbol] *; Push {U₁, U₂} into [symbol] *; |
| 20: | A ← A*; [symbol] ← [symbol] *; r ← r* |
| 21: | else |
| 22: | Push W₀ into [symbol] ; Push U₀ into [symbol] ; |
| 23: | end if |
| 24: | end while |
| 25: | return {θ, r}; // θ = {A, [symbol] , [symbol] , [symbol] } |

The algorithm 2 shown in Table 3 shows Regime Estimation in detail. First, the current tensor X^{c} is regarded as a single regime. A discrete local pattern in the current tensor X^{c} is searched by grouping similar dimensions in a target mode of the current tensor X^{c}. The first goal is to estimate the optimal parameter θ={A, B, W, U}, to fix the seasonality S, and to minimize the total cost <X^{c}; S, θ, r>.

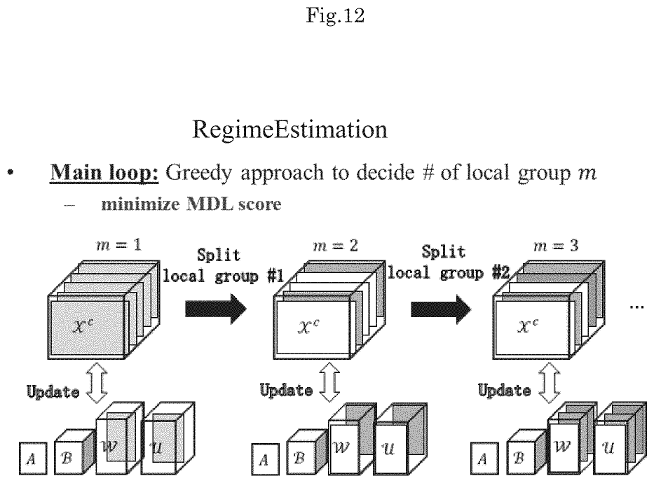

As shown in FIG. 12, the first assumption is that there is a single local activity group (that is, m=1), that is, W={W}, U={U}, and all elements ri ∈ r, where a value 1 is set for i=1, . . . , dl. In order to estimate the number of non-linear activities kz, the algorithm increases the number from 1 while the total cost can be decreased. For each estimation with kz, B=0 is first set, and only linear parameters {A, W, U} ∈ θ is optimized by use of the expectation-maximization (EM) algorithm. After the most optimal kz is obtained, the publicly known Levenberg-Marquardt (LM) algorithm is used to optimize a non-linear parameter of a preferably sparse (see Patent Literature 1) tensor B. It is to be noted that the initial states z0 and v0 are also estimated simultaneously with θ.

Next, a way to find a difference with respect to one of the aspects of a tensor will be described. An efficient stack-based algorithm that does not consider combinations of all candidates of rich attributes such as locations is proposed. W* and U* are stacks including a local activity candidate that is able to be further divided. The stacks are not empty, and the algorithm pops an entry {W₀, U₀}, and then divides a local group into two by generating {W₁, U₁} and {W₂, U₂}.

After the first local activity assignment r* for two candidate local groups is initialized, the following three procedures are iterated to estimate a new parameter set θ*.

(Procedure 1) A reconstruction error is minimized only by updating {W₁, W₂, U₁, U₂} ∈ θ*. (Procedure 2) A reconstruction error is minimized only by updating {A*, B*} ∈ θ*, and (Procedure 3) Based on a newly estimated parameter θ*, regime assignment in r* is rearranged only for the two candidate local groups.

The new assignment r*ᵢ ∈ r* of the i-th country in a divided local group, for example, is set to a local group index that minimizes the total cost <X^{c}, ᵢ|A, B, Wⱼ, Uⱼ>, where j ∈ {1, 2}. This alternative procedure makes the latent dynamical system more sophisticated with respect to a divided activity. The update of A and B affects the model quality for the entire local groups, so that all observation matrices W_{F} and U_{F} may be used in every iteration. Finally, in a case in which the coding cost with newly estimated components θ* and r* is less than the cost with undivided components θ and r, the algorithm stores a new candidate pair in the stacks W* and U* (that is, m=m+1) and performs subsequent iteration processing. Otherwise, W₀ and U₀ are used as an optimal local group.

Subsequently, Regime Compression will be described. Actual applications are configured by several individual phases. Regime Compression that makes effective and efficient updating possible is employed so that the approach may be able to detect a next dynamical pattern. The main idea is to employ/update a regime when the total cost of X^{c} is reduced. The overall Regime Compression algorithm is shown in Table 4 as Algorithm 3.

TABLE 4
Algorithm 3 REGIMECOMPRESSION (χ^{c}, Θ, [symbol] , θ, r)

| | |
|---|---|
| Input: | (a) Current tensor χ^{c} |
| | (b) Full parameter set Θ and regime assignment set [symbol] |
| | (c) Candidate regime θ and regime assignment r |

Output: Updated model set Θ* and regime assignment set [symbol] *

| | |
|---|---|
| 1: | /* Search an optimal regime within Θ */ |
| 2: | $\{ {θ}^{*} , {r}^{′} \} ← {arg min}_{{θ}^{′} ϵ θ , {r}^{′} ϵ ℛ} < {χ}^{c} ; S , {θ}^{′} , {r}^{′} > ;$ |
| 3: | if < χ^{c}; S, θ, r > is less than < χ^{c}; S, θ*, r* > then |
| 4: | Θ* ← Θ ∪ θ; [symbol] * ← [symbol] ∪ r; |
| 5: | θ* ← θ; r* ← r; // Replace an optimal regime with a |
| | new regime |
| 6: | else |
| 7: | Θ* ← Θ; [symbol] * ← [symbol] ; |
| 8: | end if |
| 9: | while < χ^{c}; S, θ*, r* > is improved do |
| 10: | Estimate θ*; // θ* ϵ Θ* |
| 11: | Estimate S; // S ϵ Θ* |
| 12: | end while |
| 13: | return {Θ*, [symbol] *}; |

When a current tensor X^{c} is given, an optimal regime is detected based on a previous model set {Θ, R} and a candidate regime {θ, r} estimated using Regime Estimation. A goal is to continue minimizing the total cost of X^{c} when a model set is given. First, the algorithm searches for an optimal regime θ* ∈ Θ and r* ∈ R. As a result, the coding cost <X^{c} |S, θ*, r*> is minimized.

In a case in which the total cost for X^{c} is less than θ* due to a newly estimated θ, θ is added to Θ. This indicates that θ is a proper summarization for an additional pattern. Otherwise, X^{c} will be described with θ*. After the algorithm updates regime shift dynamics R, the seasonality S and the current regime θ* are updated by use of the LM algorithm. More specifically, one component is alternately updated with another fixed component. The number kv of seasonal components that minimizes the reconstruction error is able to be found.

Before online forecasting is started, the number of seasonal components kv and the seasonality S need to be initialized. Therefore, two components are estimated based on independent component analysis (ICA). Specifically, a regime θ is first estimated by use of Regime Estimation. Herein, kv=0 and S=0. Subsequently, kv is varied as kv=1, 2, 3, . . . , and an appropriate number is determined so as to minimize the total cost <X; S, θ, r>. For each given kv, the ICA is applied to the matrix X ∈ R^{p×d} that is reshaped from X, and an independent component is obtained as S. It is to be noted that, in the present embodiment, the computational time of CubeCast is O(n dldk) per time point. Herein, n is the number of regimes.

Subsequently, an experiment will be described. Table 5 describes a query (search keywords) of a dataset used for the experiment.

TABLE 5

| ID | Dataset | Query |
|---|---|---|
| #1 | Apparel | zara, uniqlo, h&m, gap, primark |
| #2 | Chatapps | facebook, LINE, slack, snapchat, twitter, |
| | | telegram, viber, whatsapp |
| #3 | Hobby | soccer, baseball, basketball, running, yoga, crafts |
| #4 | LinuxOS | debian, ubuntu, centos, redhat, fedora, opensuse, |
| | | steamos, raspbian, kubuntu |
| #5 | PythonLib | numpy, scipy, sklearn, matplotlib, plotly, tensorflow |
| #6 | Shoes | booties, flats, heels, loafers, pumps, sandals, sneakers |

Hereinafter, the performance of CubeCast on a real dataset will be described. The present experiment was conducted with respect to the evaluation of effectiveness, accuracy, and scalability. It is to be noted that the present experiment was conducted on an Intel Xeon W-2123 3.6 GHz quad core CPU with 128 GB of memory, running Linux (registered trademark).
Dataset: six real event streams were used on Google (registered trademark) Trends. This contains weekly search volumes for keywords from Jan. 1, 2004 to Dec. 31, 2018 (14 years in total) from 236 countries. It is to be noted that, due to a significant amount of missing data, the top 50 countries were selected in order of the GDP scores of the countries. A value was normalized so that each sequence might have the same mean and variance (that is, z-normalization).
Baseline: the following state-of-the-art algorithm was employed for modeling and forecasting time series as a comparative example method.

### <Publicly Known Comparative Example Method>

(1) RegimeCast (see Patent Literature 1): Real-time forecasting method with multiple discrete non-linear dynamical systems. The number of latent states k=4, the model hierarchy h=2, and the model generation threshold ε=0.5·∥Xc∥ was set up.

(2) SARIMA: A state space method for obtaining a seasonal element of time series. Based on AIC, the optimal number of parameters for the model was selected from {1, 2, 4, 8}.

(3) MLDS: Multilinear dynamical system (MLDS) that learns the multilinear projection of each dimension of a sequence of latent tensors. The ranks of the latent tensors {2, 4} and {4, 8} were varied.

(4) LSTM/GRU: An RNN-based model for time series. A two-layer LSTM/GRU was stacked to encode and decode/forecast parts each of which has 50 units. In addition, a dropout rate of 0.5 to the connection of the output layer was applied. In this learning step, Adam optimization and early stopping were used.

<Discussion of Experiment>

(1) Effectiveness

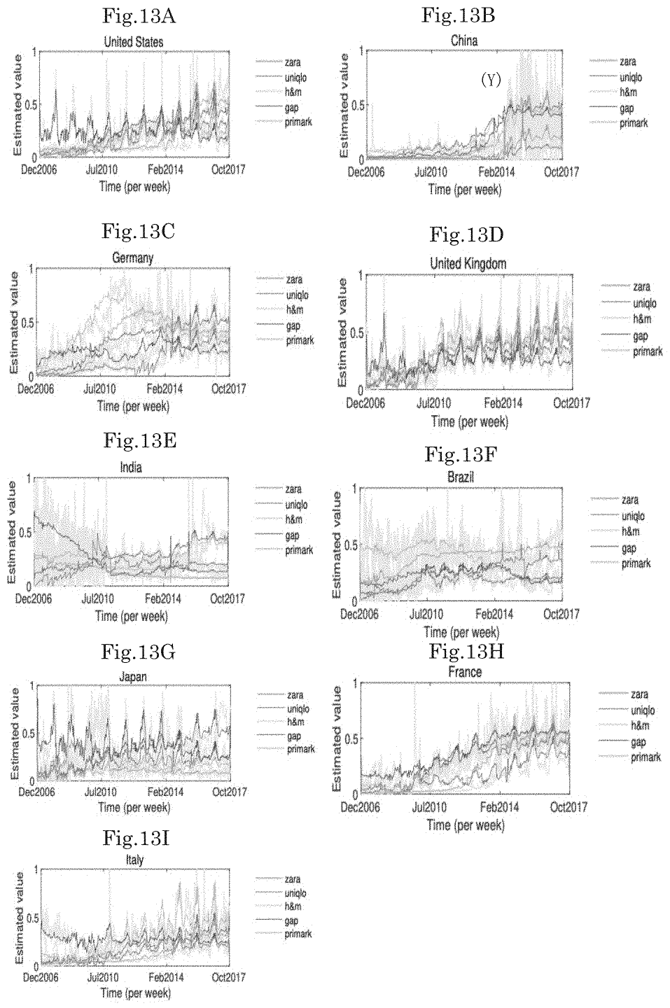

First, how CubeCast found a dynamical pattern and the structural change over time in a co-evolving tensor stream will be described. FIGS. 13A to 13I show the additional results of CubeCast in nine countries in the tensor stream about the “apparel” in Table 5. More specifically, FIG. 13A is a view showing a case of the United States, FIG. 13B is a view showing a case of China, FIG. 13C is a view showing a case of Germany, FIG. 13D is a view showing a case of the United Kingdom, FIG. 13E is a view showing a case of India, FIG. 13F is a view showing a case of Brazil, FIG. 13G is a view showing a case of Japan, FIG. 13H is a view showing a case of France, and FIG. 13I is a view showing a case of Italy. For example, as shown in a region (Y) in the data of China, the original activities are represented by faint lines, and estimated volumes are represented by solid lines. The results were obtained when the present method retained a tensor X^{c} of a length of 104 (that is, two years) at every 13th time point (that is, a quarter of a year). In addition, the datasets are assumed to have yearly seasonality, so that p=52 was set up and seasonal components were initialized with tensor streams from 2004 to 2006.

Overall, the proposed model normally captured latent dynamical patterns for multiple countries and keywords. As shown in FIGS. 13A to 13I, the detected change points are near spots at which the trends are suddenly changed. For example, in 2009, Germany became the biggest market for H&M, and thus the search volume increased at that time. This trend is obtained in September 2008. In August 2012, increasing trends are seen in China and countries in Europe. Recently, all the countries have maintained the seasonality without stopping the growth or decline of trends. The method, since compressing an input tensor into a compact model, was able to detect a comprehensive pattern change in web activity tensor train. In such a way, the present method is able to incrementally and automatically identify sudden changes in the dynamical patterns including the latent trends, seasonality and structure of a group of similar countries.

(2) Accuracy

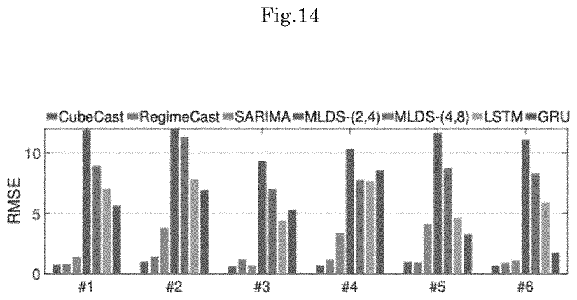

FIG. 14 is a view showing average forecasting accuracy in CubeCast. The horizontal axes #1 through #6 correspond to each of the datasets shown in Table 5, and the bar graphs correspond to the order of the present method and the comparative example method shown as above. Next, the forecasting accuracy of CubeCast compared with baselines is evaluated. FIG. 14 shows the average root mean square error (RMSE) between the original tensor and the 52-step (that is, a year) ahead estimated values using every current tensor X^{c} of length 104. A lower value indicates a higher forecasting accuracy. As a matter of course, the present method, because of being capable of modeling non-linear dynamics and seasonality simultaneously, outperforms the other time series forecasting methods for all datasets. RegimeCast as the comparative example method, although being capable of handling multiple discrete non-linear dynamics, misses a seasonal pattern. Therefore, a future value is not able to be well forecast by an online Web activity dataset. A linear model is unsuitable for long-term (that is, multiple steps ahead) forecasting.

(3) Scalability

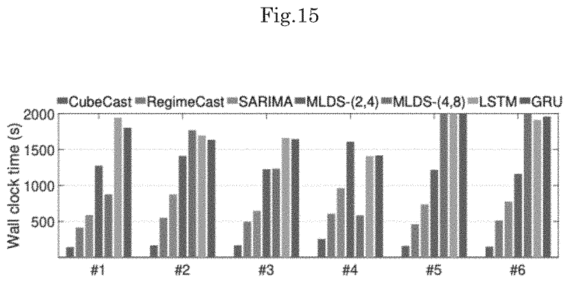

Finally, the computational time needed by CubeCast for large tensor time series is evaluated by comparison with the comparative example method. FIG. 15 is a view showing average wall clock time (average response time) in Google (registered trademark) Trends. The horizontal axes #1 through #6 correspond to each of the datasets shown in Table 5, and the bar graphs correspond to the order of the present method and the comparative example method shown as above. As expected, this method achieves a great improvement in terms of computational time. The RNN (Recurrent Neural Network)-based model needs a significant amount of learning time while CubeCast is able to identify the current regime including several groups of countries and quickly and continuously forecast a future event. RegimeCast and SARIMA as the comparative example method, since being incapable of handling tensor data, need to process a tensor as a large matrix, which incurs a high computational cost. Overall, CubeCast was very efficient for the real-time/long-term forecasting of tensor series. In addition, the scalability of CubeCast was evaluated in detail.

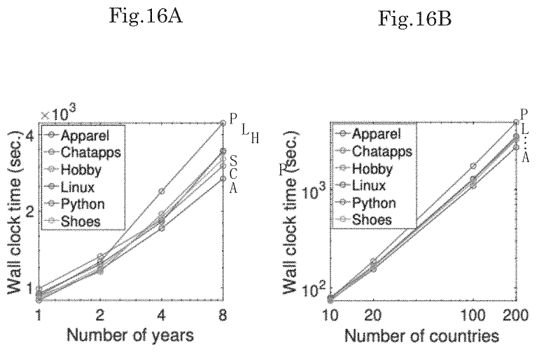

FIG. 16A and FIG. 16B are views showing the average wall clock time of Regime Estimation when the tensor size is varied, that is, views showing a relationship with the duration and the number of countries on six Google (registered trademark) Trends datasets, and FIG. 16A shows a relationship with the duration (tc) and FIG. 16B shows a relationship with the number of countries (dl). It is to be noted that the graph lines in FIG. 16A and FIG. 16B are associated with initial letters of the Google (registered trademark) Trends datasets, respectively, by indicating the initial letters on the right end of the lines. Thanks to the proposed stack-based country-specific pattern identification procedure, the complexity of Regime Estimation linearly scales with both the duration and the number of countries. As a result, CubeCast was found to have a desirable property in that large tensor streams are able to be forecast based on multi-aspect dynamic pattern mining.

As described above, CubeCast (the present method) has proposed an effective and efficient forecasting method for large time-evolving tensor series. The present method is able to recognize basic trends and seasonality in input observation by extracting the latent non-linear dynamical system. In addition, the present method was shown to have advantages such as being effective, automatic, and scalable, over the above comparative example method with respect to time series forecasting using real Google (registered trademark) search volume datasets. Being effective is to effectively capture complex non-linear dynamics for tensor time series when a long-term future value is forecast. Being automatic is to automatically recognize all components in regimes and the temporal/structural innovations of all the components in the regimes without the need of prior knowledge of data. Being scalable means that the computational time of CubeCast is independent of the time series length.

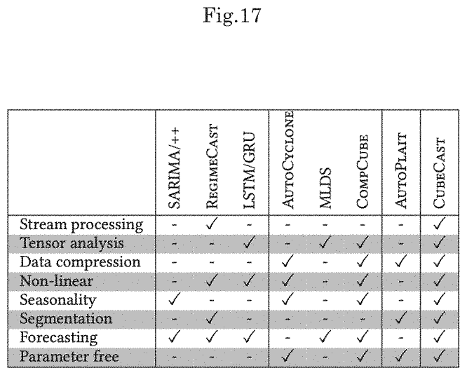

Moreover, FIG. 17 is a table showing presence or absence of functions of CubeCast and the comparative example method. As shown in FIG. 17, CubeCast is able to execute all the functions.

It is to be noted that the present invention is applicable to grouping of locations by country as well as by region, gender, and various other perspectives. In addition, the present invention may also be applicable to marketing and purchase motivation of consumers. Moreover, the present invention is applicable to human activities that include temporal periodicity in nature, in addition to social activities.

As described above, a forecasting apparatus according to the present invention, in the forecasting apparatus that forecasts an event after a predetermined time by applying estimated data reproduced from time-series data in multidimension that passes through a current window, preferably includes a storage unit that sequentially stores the time-series data in the multidimension that passes through the current window, a non-linear transformation unit that, among the time-series data in the multidimension to be outputted from the storage unit, from the time-series data in a part of dimensions that are related to trends, non-linearly transforms and outputs latent first data showing the trends, and, among the time-series data in the multidimension to be outputted from the storage unit, from the time-series data in a part of dimensions that are related to seasonal intensity, linearly transforms and outputs latent second data showing the seasonal intensity, an observation matrix unit that includes a first observation matrix that reproduces the first data to first estimated data of an original number of dimensions, and a second observation matrix that, by use of seasonality information that has been set in a seasonality setting unit, reproduces the second data to second estimated data of an original number of dimensions, as seasonality data, and further adds output of the first observation matrix and the second observation matrix and outputs as the estimated data.

In addition, a forecasting method according to the present invention, in the forecasting method that forecasts an event after a predetermined time by applying estimated data reproduced from time-series data in multidimension that passes through a current window, preferably includes sequentially storing in a storage unit the time-series data in the multidimension that passes through the current window, among the time-series data in the multidimension to be outputted from the storage unit, from time-series data in a part of dimensions that are related to trends, non-linearly transforming and outputting latent first data showing the trends, and, among the time-series data in the multidimension to be outputted from the storage unit, from the time-series data in a part of dimensions that are related to seasonal intensity, and linearly transforming and outputting latent second data showing the seasonal intensity, and reproducing the first data to first estimated data of an original number of dimensions by a first observation matrix, and, by use of seasonality information that has been set in a seasonality setting unit, reproducing the second data to second estimated data of an original number of dimensions by a second observation matrix, as seasonality data, and further adding output of the first observation matrix and the second observation matrix and outputting as the estimated data.

Moreover, a non-transitory computer readable storage medium storing a program according to the present invention causes a computer to preferably implement, in forecasting an event after a predetermined time by applying estimated data reproduced from time-series data in multidimension that passes through a current window, sequentially storing in a storage unit the time-series data in the multidimension that passes through the current window, among the time-series data in the multidimension to be outputted from the storage unit, from the time-series data in a part of dimensions that are related to trends, non-linearly transforming and outputting latent first data showing the trends, and, among the time-series data in the multidimension to be outputted from the storage unit, from the time-series data in a part of dimensions that are related to seasonal intensity, and linearly transforming and outputting latent second data showing the seasonal intensity, and reproducing the first data to first estimated data of an original number of dimensions by a first observation matrix, and, by use of seasonality information that has been set in a seasonality setting unit, reproducing the second data to second estimated data of an original number of dimensions by a second observation matrix, as seasonality data, and further adding output of the first observation matrix and the second observation matrix and outputting as the estimated data.

According to these inventions, from the time-series data of the current window in a part of dimensions that are related to trends and the time-series data of the current window in a part of dimensions that are related to seasonal intensity, by employing, for example, an adaptive non-linear dynamical system including a differential equation as the non-linear transformation unit, the latent first data showing the trends and the latent second data showing the seasonal intensity are extracted by non-linear transformation and by linear transformation, that is, transformed and generated. Then, the first data is reproduced by the first observation matrix to the first estimated data of the original number of dimensions, and the second data is reproduced by the second observation matrix to the second estimated data of the original number of dimensions, by use of seasonality information that has been set in the seasonality setting unit, and the first estimated data and the second estimated data are further added to output of the first observation matrix and the second observation matrix and outputted as the estimated data. Therefore, latent trends and seasonality are extracted from the time-series data and reproduced so that original time-series data may be estimated by a model of the data of the latent trends and the seasonality. The forecasting, since being performed by the model at this time, is performed effectively and highly accurately.

In addition, the present invention preferably includes a model parameter estimation unit, and the model parameter estimation unit preferably adjusts a parameter of the non-linear transformation unit, the first observation matrix, and the second observation matrix, and a setting content of the seasonality setting unit so as to minimize a difference between the estimated data being a result of addition of the first estimated data and the second estimated data, and the time-series data of the current window. According to this configuration, the estimated data being the result of addition of the first estimated data and the second estimated data may be approximated to the time-series data of the current window, and the model at this time is able to be used to improve forecasting accuracy.

Moreover, the non-linear transformation unit, in a case in which the multidimension is d-dimensional, preferably receives an input and sends an output of the time-series data for k-dimension (<d) that is obtained by combining the time-series data for kz-dimension related to the trends and the time-series data for kv-dimension related to the seasonal intensity. According to this configuration, latent data is captured in the smaller number of dimensions.

In addition, the non-linear transformation unit is preferably connected in series to the two-dimensional matrix that performs linear transformation and the three-dimensional tensor matrix that performs non-linear transformation. According to this configuration, the latent second data showing the seasonal intensity is captured in addition to the latent first data showing the trends with the matrix and the tensor matrix.

Moreover, the present invention preferably includes a regime update unit, and the time-series data is preferably configured by an element of a keyword, a location, and elapsed time information, and the regime update unit preferably divides the first observation matrix and the second observation matrix into multiple regimes at least with respect to the element of the location. According to this configuration, a new regime by use of a location and even further a keyword as the element is able to be increased, which makes it possible to improve forecasting accuracy. It is to be noted that the element of the location may include a place, a region, a country, and other social or physical distinction.

In addition, the present invention preferably includes a resume addition unit, and the regime update unit preferably compares a sum of model description cost and data encoding cost by applying principle of the minimum description length (MDL), with respect to an original regime model and a divided new regime model, and the regime addition unit, in a case in which cost of the new regime model is lower, preferably additionally registers a parameter configuring the new regime model in a parameter set storage unit. According to this configuration, determination to set a new regime model is made automatically.

### REFERENCE SIGNS LIST

100 forecasting apparatus
1 calculation unit
10 model parameter estimation unit
11 non-linear transformation unit
14 seasonality setting unit
16, 17 observation matrix
20 regime update unit
30 regime addition unit
40 forecasting unit
101 program storage unit
102 data stream storage unit
103 current window storage unit
104 parameter set storage unit

1. A forecasting apparatus that forecasts an event after a predetermined time by applying estimated data reproduced from time-series data in multidimension that passes through a current window, the forecasting apparatus comprising:
a storage unit that sequentially stores the time-series data in the multidimension that passes through the current window;
a non-linear transformation unit that, among the time-series data in the multidimension to be outputted from the storage unit, from the time-series data in a part of dimensions that are related to trends, non-linearly transforms and outputs latent first data showing the trends, and, among the time-series data in the multidimension to be outputted from the storage unit, from the time-series data in a part of dimensions that are related to seasonal intensity, linearly transforms and outputs latent second data showing the seasonal intensity; and
an observation matrix unit that includes a first observation matrix that reproduces the first data to first estimated data of an original number of dimensions, and a second observation matrix that, by use of seasonality information that has been set in a seasonality setting unit, reproduces the second data to second estimated data of an original number of dimensions, as seasonality data, and further adds output of the first observation matrix and the second observation matrix and outputs as the estimated data.

2. The forecasting apparatus according to claim 1, comprising a model parameter estimation unit, wherein the model parameter estimation unit adjusts a parameter of the non-linear transformation unit, the first observation matrix, and the second observation matrix, and a setting content of the seasonality setting unit so as to minimize a difference between the estimated data being a result of addition of the first estimated data and the second estimated data, and the time-series data of the current window.

3. The forecasting apparatus according to claim 1, wherein the non-linear transformation unit, in a case in which the multidimension is d-dimensional, receives an input and sends an output of the time-series data for k-dimension (<d) that is obtained by combining the time-series data for kz-dimension related to the trends and the time-series data for kv-dimension related to the seasonal intensity.

4. The forecasting apparatus according to claim 1, wherein the non-linear transformation unit is configured by connecting in series a two-dimensional matrix that performs linear transformation and a three-dimensional tensor matrix that performs non-linear transformation.

5. The forecasting apparatus according to claim 1, further comprising a regime update unit, wherein:
the time-series data is configured by an element of a keyword, a location, and elapsed time information; and
the regime update unit divides the first observation matrix and the second observation matrix into multiple regimes at least with respect to the element of the location.

6. The forecasting apparatus according to claim 5, further comprising a regime addition unit, wherein:
the regime update unit compares a sum of model description cost and data encoding cost, by applying principle of minimum description length, with respect to an original regime model and a divided new regime model; and
the regime addition unit, in a case in which cost of the new regime model is lower, additionally registers a parameter configuring the new regime model in a parameter set storage unit.

7. A forecasting method that forecasts an event after a predetermined time by applying estimated data reproduced from time-series data in multidimension that passes through a current window, the forecasting method comprising:
sequentially storing in a storage unit the time-series data in the multidimension that passes through the current window;
among the time-series data in the multidimension to be outputted from the storage unit, from the time-series data in a part of dimensions that are related to trends, non-linearly transforming and outputting latent first data showing the trends, and, among the time-series data in the multidimension to be outputted from the storage unit, from the time-series data in a part of dimensions that are related to seasonal intensity, and linearly transforming and outputting latent second data showing the seasonal intensity; and
reproducing the first data to first estimated data of an original number of dimensions by a first observation matrix, and, by use of seasonality information that has been set in a seasonality setting unit, reproducing the second data to second estimated data of an original number of dimensions by a second observation matrix, as seasonality data, and further adding output of the first observation matrix and the second observation matrix and outputting as the estimated data.

8. A non-transitory computer readable storage medium storing a program that causes a computer to implement, in forecasting an event after a predetermined time by applying estimated data reproduced from time-series data in multidimension that passes through a current window:
sequentially storing in a storage unit the time-series data in the multidimension that passes through the current window;
among the time-series data in the multidimension to be outputted from the storage unit, from the time-series data in a part of dimensions that are related to trends, non-linearly transforming and outputting latent first data showing the trends, and, among the time-series data in the multidimension to be outputted from the storage unit, from the time-series data in a part of dimensions that are related to seasonal intensity, and linearly transforming and outputting latent second data showing the seasonal intensity; and
reproducing the first data to first estimated data of an original number of dimensions by a first observation matrix, and, by use of seasonality information that has been set in a seasonality setting unit, reproducing the second data to second estimated data of an original number of dimensions by a second observation matrix, as seasonality data, and further adding output of the first observation matrix and the second observation matrix and outputting as the estimated data.
